(19) United States
(12) Patent Application Publication
(10) Pub. No.: US 2002/0161929 A1
(43) Pub. Date: Oct. 31, 2002

(54) Method and apparatus for routing data through a computer network

(76) Inventors: Donald A. Longerbeam, Roseville, CA (US); Keith Hoek SR., Wheatland, CA (US); Kelly M. Hall, Davis, CA (US)

Correspondence Address: DKW LAW GROUP, P.C., 58TH FLOOR - USX TOWER, 600 GRANT STREET, PITTSBURGH, PA, 15219, US

(21) Appl. No.: 09/945,577

(22) Filed: Aug. 31, 2001

Related U.S. Application Data
(63) Continuation-in-part of application No. 09/845,847, filed on Apr. 30, 2001.

(51) Int. Cl. G06F 15/16

(52) U.S. Cl. 709/250; 710/314

(57) ABSTRACT

The present invention relates to an improved method and apparatus for routing data and, more particularly, to a novel backplane for use in a data routing device, the backplane being an active backplane employing a PCI-PCI bridge interface chip and a bus operating at up to 64-bit and 66 MHz frequency. The present invention is also directed to a data routing device employing such a novel passive backplane.

### RELATED APPLICATION

This application is a continuation-in-part of commonly assigned application Ser. No. 09/845,847, filed Apr. 30, 2001.

### FIELD OF THE INVENTION

The present invention relates to a method and apparatus for routing data, and more particularly to a novel backplane for use in a data routing device, said backplane being an active backplane having a 64-bit PCI bus operating at up to 66 MHz. The present invention is also directed to a data routing device employing such a novel 64-bit/66 MHz active backplane.

### BACKGROUND OF THE INVENTION

Networked computers have become a mainstay in all facets of life. One important benefit of most networked computer systems is the ability to easily and quickly share information/data between networked computers. Of paramount consideration in the design and manufacture of network routing devices are the operating speed or throughput of the system and the density of the ports that can be packaged in a single unit.

The networks providing data communication between computers can be local in nature linking a relatively few concentrated computers via a local area network (“LAN”) or over a relatively wider area via a wide area network (“WAN”), or range from inter-connecting any or all of individual computers, LANs and/or WANs via a global computer network, as for example the Internet and its World Wide Web (“WEB”) subcomponent to interconnect computers the world over. Unless otherwise clear from the context of use, the term “network” hereinafter shall include LANs, WANs, global networks and/or any other networking of computers to provide data communication therebetween.

Much advancement has been made in the relatively recent past in the infrastructure linking such computers via a network. This includes advancements in both software and hardware necessary for the operation of such networks.

The term “hardware” includes cabling, jacks and other devices necessary to make the physical connection between the computers or other devices on the network to enable data to flow over the network. The term “hardware” also includes computer cards, computer boards and other devices that may/must be inserted into a computer that is to be linked over the network to permit that computer to share information over the network. The term “hardware” also includes devices that are separate and apart from the computers that are to be linked over the network, which devices are placed within the computer network and become a part of the network's infrastructure and operate to perform some function necessary for the operation of the network. Devices in this last category of hardware include routers and bridges, for example.

More particularly, it is most common in the presently available networking systems for large concentrations of data that is to be transferred from a first computer to a second computer on the network to be packetized. In this process the large data file that is to be transferred is broken into smaller subcomponents or “data packets” and the data packets are provided with address information that indicates where that packet destination (the second computer) may be found on the network. The data packets are then sent over the network via a variety of paths and devices on the network forward any given data packet in the direction of its intended destination using the address information described above. The data packets are forwarded in any order until they arrive at the desired destination, whereupon the packets are reassembled at the destination (e.g., the second computer) to recreate the transferred data on the second computer. As may be appreciated, at any one time there are millions of packets flowing over a computer network of any size, and devices such as routers operate as junction points between the many paths of the network receiving the data packets and forwarding them along the appropriate path of the network toward the data packet's intended destination.

It is a difficult enough task to complete this operation and to transfer the data packets with sufficient speed and accuracy as to render the network useful without malicious intervention, but the matter is further complicated when intentionally or inadvertently an entity floods the network with data packets that overload or otherwise damage the ability of the network to route the data packets over the network. Intentional attacks are sometimes referred to as denial of service (“DoS”) attacks and if successful render the attacked computer, network, or other device temporarily or permanently unable to effectively transfer data over the computer network. Particularly troublesome are intentional attempts by computer hackers to interrupt or otherwise destroy data flow. Therefore, there have been both hardware and software developments, but particularly software developments, that attempt to thwart such attacks, and such software may reside on the interconnected computers, on the infrastructure devices such as the router described above, or both. These systems to prevent DoS attacks are sometimes referred to as a “firewall” in the sense that as a firewall in a building or other structure operates to provide protection from a fire on one side of the wall for occupants or equipment on the other, these systems operate to protect the computer or other device from attacks coming from the computer network. As may be appreciated, however, the term “firewall” is generally not limited to DoS attack protection alone, and firewalls typically provide other protections such as protection from computer viruses and/or privacy/access restrictions/protections, among others. Thus, for example, a routing device may include several junctions (referred to as “ports”) with the computer network for receiving and forwarding data packets and a means within the router for reading the address information and selecting the proper path along which to forward the data packet, and the router may further be equipped with firewall protection to prevent, for example, DoS attacks on the router itself or the computer network as a whole.

A router generally includes at least the following components, not in any particular order. First, it is generally housed within a box-like housing. Second, there is typically a power supply to enable the unit to function, which is typically powered by plugging the unit into an AC current, 120 volt power source and third, an on/off switch to turn the unit off and on. Fourth, the router usually includes a plurality of ports, also known as interfaces, for example, between three and twelve in number, which are visible and accessible from the exterior surface of the device, and which physically resemble telephone jacks to enable the unit to be connected via cabling to several computers or devices on the network. The ports are often named in terms of the amount of data they can carry. For example, 10/100 megabit (“MB”) ports can carry zero to 100 megabits per second of data. One gigabit ports can carry 125,000,000 bytes of data per second. Routers may include a mixture of such ports, wherein some may for example be 10/100 MB ports whereas others are one gigabit ports all in the same router. As may be appreciated, the rate of data transfer is not a factor of the port alone, but rather it is the supporting circuitry described below that enables a named port to operate at or about its named speed.

The ports themselves typically reside on a fifth component, an electronic circuit board or card. The port-bearing electronic circuit board is often referred to as a network interface card (“NIC”).

Any number of ports may be associated with a NIC, but often there are four ports affixed to each NIC. A router having 12 ports would then, for this example, include three NICs.

The three port-bearing NICs are plugged into a sixth component, a common electronic circuit board or card, known as a backplane, each NIC being inserted into its own respective plug, slot or socket on the backplane. A backplane operates much like an electrical junction box and, more particularly, is an electronic circuit board containing circuitry and sockets into which additional electronic devices on other circuit boards or cards can be plugged. The backplane in this example operates to provide data communication pathways between the 12 ports on the three port-bearing NICs.

A backplane typically operates only as an intermediary board to provide pathways between the various ports, and the backplane is typically itself placed in data communication via another plug, slot or socket on the backplane with a seventh component, which is another electronic circuit board, which other electronic circuit board in fact exchanges data and address information and operates as the “brain” for the device deciding which pathway the received data packet should be forwarded along. The decision-making electronic circuit board is referred to as a single board computer (“SBC”).

Finally, typical router includes as an eighth component a plurality of fans to keep the temperature in the unit fairly constant and to avoid damage to the components from heat.

The SBC may or may not have an operating system associated with it. The router may also include additional components to permit an administrator of the router to configure certain operational or other parameters of the router and/or the SBC. As used herein a “user” generally refers to any entity utilizing the router, but the term “administrator” is generally reserved for an entity having permissions to configure the router. The additional components may include interfaces for keyboards and monitors and serial or other ports to permit data communication with a terminal or other device to permit configuration of the router and/or the SBC. The router and/or the SBC may be configured by directly plugging in a keyboard and/or terminal or, particularly where the SBC has its own operating system, it may be configured remotely by an administrator over the network via the existing ports or additional ports or interfaces added for that express purpose.

Backplane systems do not have a motherboard in the true sense of the word. In a backplane system, the components normally found on a motherboard are located on the SBC.

Backplane systems come in two main types: passive and active.

A passive backplane means that the backplane board contains only signal traces and connectors but does not contain active control or buffering circuitry. All of the circuitry found on a conventional motherboard is contained on one or more expansion cards installed in slots on the backplane. Some backplane systems incorporate the entire system circuitry into a single mothercard (e.g., the SBC). The mothercard is essentially a complete motherboard that is designed to plug into a slot in the passive backplane. The passive backplane/mothercard concept allows the entire system to be easily upgraded by changing one or more cards.

An active backplane means the main backplane board contains active control and buffering circuitry. In essence, such backplanes include an additional integrated circuit chip (a PCI-to-PCI bridge chip), which operates like a repeater/buffer/synchronizer to facilitate movement of the data packets over the various circuit pathways on the backplane. Previously, at the maximum available bus speed of 33 MHz, the PCI bridge created a system bottleneck on the backplane as all data must pass over the chip which creates an inherent time delay. At that bus speed, it was more efficient and cost effective to employ the passive backplane. The bridge added additional cost to the manufacture of the backplane.

PCI refers to peripheral component interconnect. PCI is a standardized data transfer mechanism developed by a consortium of several companies and administered by a group known as the PCI SIG or PCI Special Interest Group to ensure widespread compatibility between different peripheral devices, and avoid permutations of local bus architectures which varied, or which were peculiar to a specific processor bus. Currently, the PCI standard call for the ability to support up to 66 MHz operating speed.

Keeping the SBC on its own circuit board as opposed to placing the processor complex on the active backplane allows the user to easily upgrade to a new processor type by changing only the SBC card. In effect, it amounts to a modular motherboard with a replaceable processor section. In devices other than routers, as for example, most modern personal computer (“PC”) systems that use a backplane design use an active backplane/processor complex. Both IBM and Compaq have used this type of design in some of their high-end (server class) systems, for example. The theoretical advantage of a backplane system, however, is that you can upgrade it easily to a new processor and new level of performance by changing a single card (e.g., the SBC card). If the processor complex were built into the backplane board to form a type of motherboard-design system, upgrading the processor would require changing the entire processor complex/backplane combination, a seemingly more formidable task. However, development of the upgradeable processor (e.g., Intel has designed all 486, Pentium, Pentium Pro, and Pentium II processors to be upgradeable to faster (sometimes called OverDrive) processors in the future by simply swapping (or adding) the new processor chip) has created the possibility of changing only the processor chip for a faster one, which may be the easiest and generally most cost-effective way to upgrade without changing the entire processor complex/backplane combination.

Whether active or passive, for all routers and indeed for all computer network hardware and even arguably for all computer equipment, there is ever-felt marketplace pressure and there remains a need in the art to design and build a router in such a way that it is easier to manufacture, less expensive to manufacture, faster to manufacture, smaller in overall dimensional size and which can more quickly and accurately process data, preferably with new and additional functionality (e.g., firewall protection, etc.) over known router designs.

### SUMMARY OF THE INVENTION

What is disclosed is a method and apparatus for routing data through a computer network. In a network router, there is an active backplane board for coupling an external network data path with a single board computer (SBC) for routing data through a network. The backplane includes a backplane board substrate with two data buses, each data bus comprising a plurality of electrical pathways. Also, a plurality of electronic circuit board expansion slots is located on the substrate. The expansion slots are in data communication with one of the buses. Each slot is adapted to receive a network interface card (NIC) and to, in turn, couple the NIC to one of the buses. The expansion slots retain the NIC spaced apart from but in a plane parallel with the backplane board substrate.

The backplane board also includes means for electrically coupling the first (primary) data bus to an SBC and at least one bridge means for electronically coupling the primary data bus to a second data bus. The bridge means provides buffering and synchronization of data transferred between said at least two data buses. The bridge means has two separate and independent input and output means.

The first expansion slot is electrically common through the primary data bus with the primary port of the bridge and with the coupling means to SBC.

A pair of expansion slots is also electrically common with the secondary data bus. The secondary data bus is also electrically common with the bridge secondary port.

In the preferred embodiment, the bridge means comprises a peripheral component interconnect (PCI)-to-PCI bridge chip.

It is an object of the present invention to provide a high performance router, integrating intelligent adaptive firewall, network load balancing and intrusion detection systems which are tightly integrated for real time updates.

It is another object of the present invention to provide comprehensive protection from malicious outside attacks on the network and internal network security breaches.

It is yet another object of the present invention to provide firewall and intrusion detection systems (“IDS”).

It is a further object of the present invention to provide a multi-port, linearly sequential single unit height device that is exceptionally compact and rack mountable.

It is another object of the present invention to provide a high performance integrated router that includes web browser management interface and secure shell command line interface.

It is a further object of the present invention to eliminate the need for separate devices to perform routing, firewall, load balancing functions and IDS.

It is an object of the present invention to provide a network router that consumes minimal floor and rack space.

It is a further object of the present invention to provide a multiple function integrated routing device that easily integrates with existing networks using industry standard protocols.

### BRIEF DESCRIPTION OF THE DRAWINGS

FIG. 1 is a front perspective view of the novel router of the present invention;

FIG. 2 is a back perspective view of the novel router of the present invention;

FIG. 3 is a front perspective view of the components of the novel router of the present invention;

FIG. 4 is a top plan view of the active backplane printed circuit board;

FIG. 5 is a bottom plan view of the active backplane printed circuit board; and

FIG. 6 is a graph showing network throughput comparison results.

### DETAILED DESCRIPTION OF THE PREFERRED EMBODIMENTS

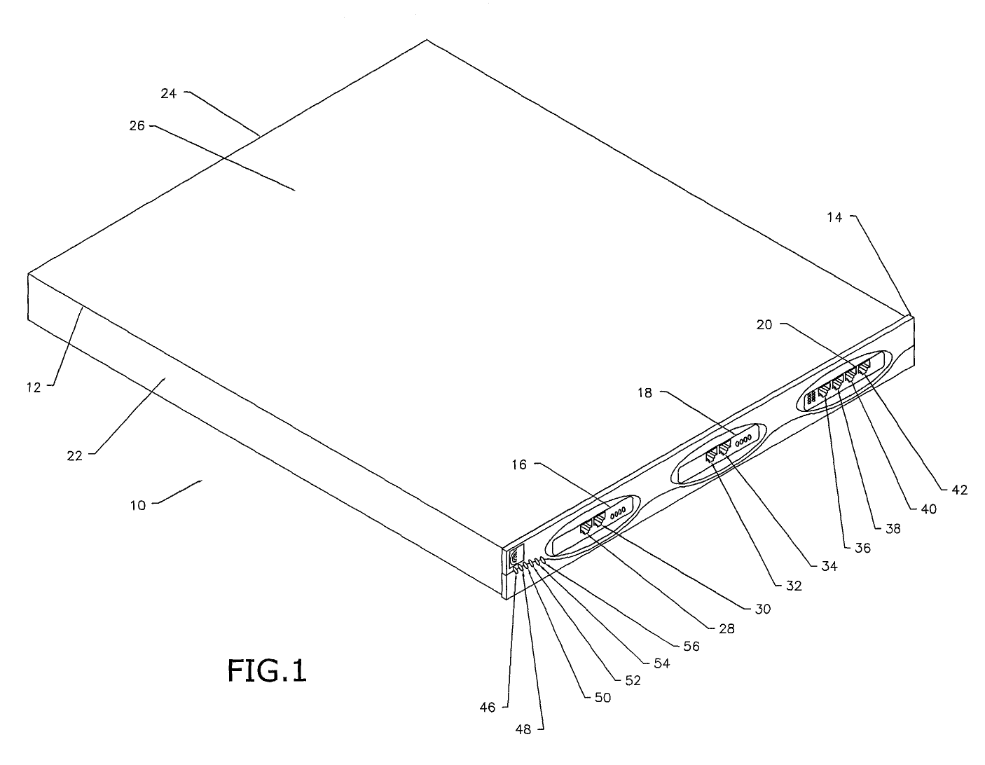

Illustrated in FIG. 1 is a front perspective view of a novel router 10 of the present invention. The novel router 10 includes a chassis 12 in which the components described below are retained. The chassis includes a front wall 14 having openings 16, 18 and 20 therethrough, sidewalls 22 and a rear wall 24. The chassis 12 is enclosed within a cover 26, which cover 26 is affixed to the chassis 12 by any means known in the art, typically with a plurality of screws, not shown.

The openings 16, 18 and 20 are adapted to receive there through ports 28-42. The precise number of ports is not limiting in the present invention, and more or less ports may be employed within the scope of the present invention. Also, the capacity of the ports may be the same or may be different. For example, ports 28-34 in the example illustrated are one gigabit (Gb) ports, and ports 36-42 collectively are 10/100 megabit (Mb) ports, respectively. This example is non-limiting and the present invention may include any combination of ports in any data carrying capacity. The ports operate as interfaces to permit cabling to be inserted into the ports to provide data communication between the router 10 and other devices, such as computers, to be networked via the router 10 or other devices such as, but not limited to, other routers. In fact, any PCI based network interface card may be used in the ports, e.g., cards, to interface to T-1, OC-*, token ring, ARCNET, V.35, FDDI, ATM, DSL, ISDN, or other devices, which allows the backplane to be adaptable to a variety of networking environments.

Also illustrated in FIG. 1 are a plurality of LEDs 46-58 which operate to provide the administrator of the router 10 with certain information regarding the operation and performance of the router 10. The precise number of LEDs and their placement on the router 10 are not limiting to the present invention, and more or less LEDs or other optical and/or audible devices may be employed to provide the user with more or less operational or performance feedback. However, in this embodiment the six LEDs 48-56 do perform certain useful functions.

In normal operation, the LEDs provide a visual indication of network activity through the router. The LEDs provide a bar graph display where more energized LEDs indicate more network traffic through the router. When two routers are paired together to form a high-availability router, one LED in each router acts as a “heartbeat” to provide a visual indication that each router is communicating with the other. The remaining five LEDs continue to act as a bar graph of network traffic.

Additional LEDs (not shown) may optionally be placed strategically on the top side of backplane board 108. The purpose of these LEDs is to provide visual indication whether voltage is present at predetermined points on the board 108.

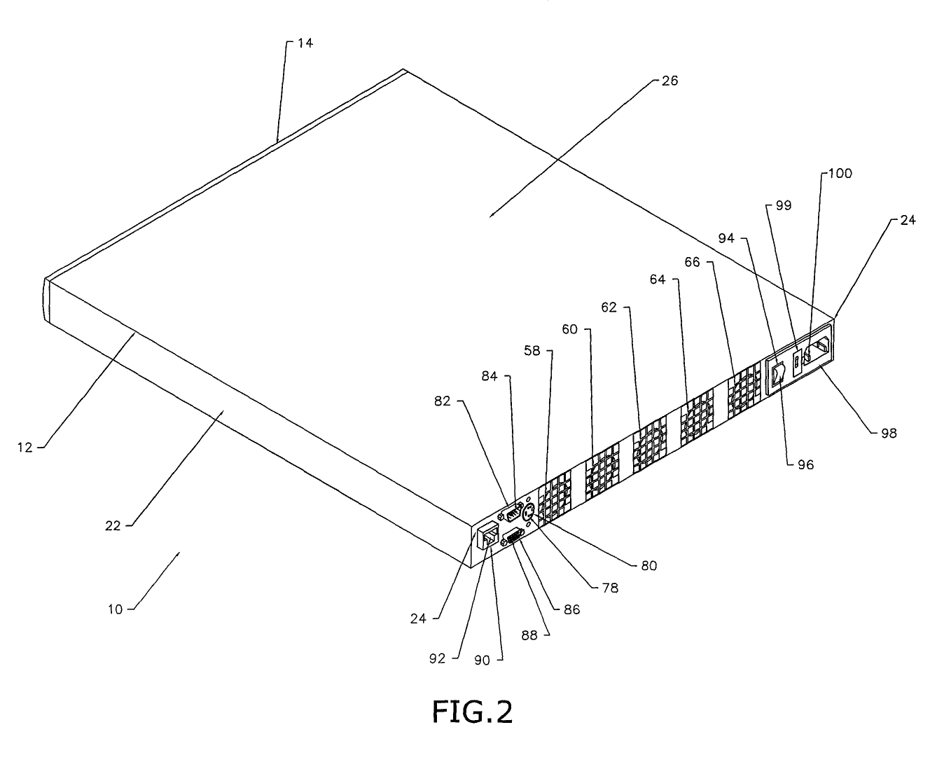

Referring now to FIG. 2, there is illustrated a rear perspective view of the router 10. As illustrated in FIG. 2, cover 26 is in place over the chassis 12. The rear wall 24 contains a plurality of openings therein to accommodate certain purposes. The precise number of openings and their placement are not limiting to the present invention and more or less openings may be employed as within the scope of the present invention. However, as illustrated in FIG. 2 there is a plurality of openings 58-66 to accommodate airflow past a plurality of cooling fans 68-76.

In the embodiment illustrated in FIG. 2, an opening 78 is provided to accommodate a circular pin connector 80 which may be used, for example, to permit a keyboard or other device to interface with the router 10, for example, for the purpose of configuring the router 10. An opening 82 is provided to accommodate a D-SUB connector 84 which may be used to interface a terminal with the router 10, for example, for the purpose of configuring the router 10. An opening 86 may be provided to accommodate a D-SUB connector 88 to permit a monitor or other display device to be interfaced with the router 10, also for example, for the purpose of configuring the router 10. An opening 90 may be provided to accommodate an RJ-45 connector 92 which may be used to interface a computer network with the router 10. For example, for the purpose of configuring the router 10, some network installations use dedicated, private computer networks solely to configure and monitor their networking equipment.

An opening 94 may be provided to permit an on/off switch 96 to be provided to operate the router 10. An opening 98 may be provided to accommodate a power entry module 100 for the purpose of supplying electrical power to the router 10. Finally, a fuse holder 99 is mounted adjacent the power entry module 100 for easy replacement when a fuse blows. The fuse holder 99, power switch 96 and power entry module 100 are typically provided as a unit to reduce the number of parts, interconnecting wires, and number of discrete openings required in the housing. The combination unit is referred to as a “power entry module”. As stated above, the exact number of openings, their placement and their purposes are not limited to those illustrated in FIG. 2, and more or less openings may be provided for more or less purposes.

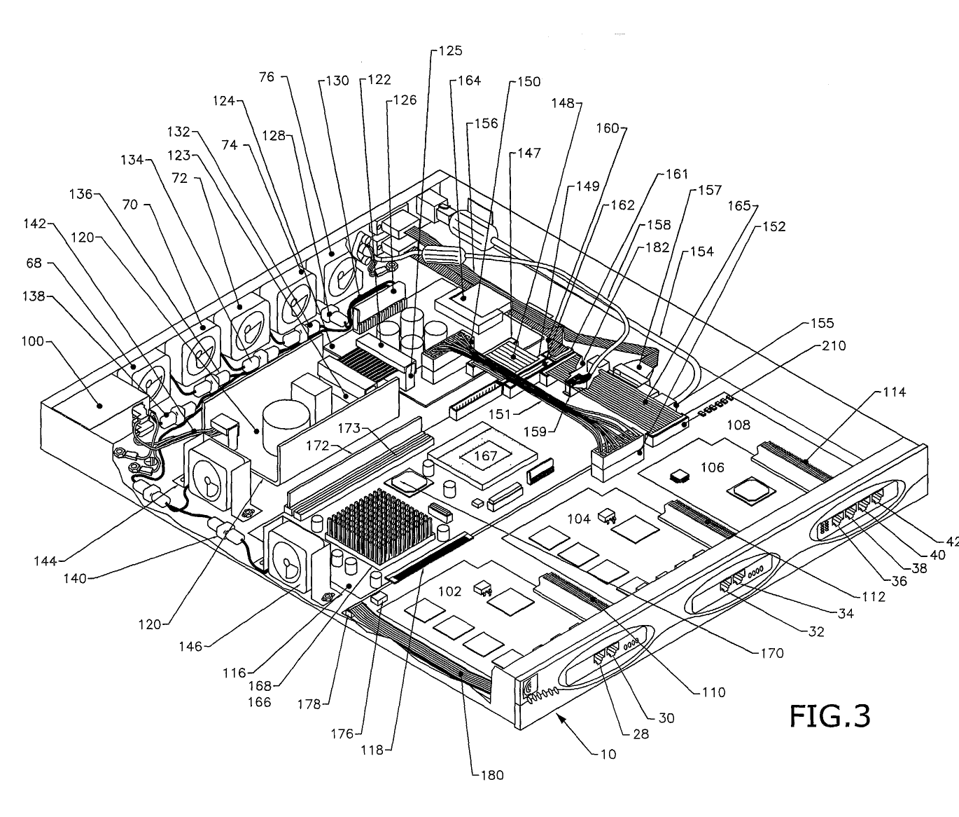

Referring now to FIG. 3, there is illustrated a front perspective schematic view of the router 10 with the cover 26 off, illustrating the major components of the router 10. The ports 28, 30 reside on and are in data communication with a network interface card (“NIC”) 102. The ports 32, 34 reside on and are in data communication with a NIC 104. The ports 36-42 reside on and are in data communication with a NIC 106.

NICs 102-106 reside on and are in data communication with either a primary bus 200 or a secondary bus 204 located on backplane board 108. More particularly, NIC 102 is supported on and provides its data communication with backplane board 108 via a peripheral component interface (“PCI”) connector 110. NIC 104 is supported on and provides its data communication with backplane board 108 via a PCI connector 112. Finally, NIC 106 is supported on and provides its data communication with backplane board 108 via a PCI connector 114.

Data entering any of the ports 28-42 is then in communication over the respective NIC to the backplane board 108. Backplane board 108 is then in data communication with a single board computer (“SBC”) 116 via a PCI Industrial computer manufacturing group (“PIC MG”) connector 118.

Power is supplied to the backplane board 108 from a power supply 120. The electrical current carried by a wiring harness 122 is supplied to a power distribution board 124 via electrical power junction blocks 123, 125.

Electrical power is transferred from power distribution board 124 through a power connector 126 to connectors 128-140. Connectors 128-140 feed power to the cooling fans 68-76, 144 and 146. Preferably, power distribution board 124 contains fuses (not shown) to protect the individual fan connections. Power input to power supply 120 is derived through input wires 142 connected to the back of power entry module 100. Power supply cooling fan 144 is mounted adjacent to the power supply 120 to provide additional cooling and to lower the ambient operating temperature of power supply 120. SBC cooling fan 146 is mounted adjacent SBC 116 and, more particularly, adjacent to a processor 166 and a processor heat sink 168. Processor heat sink 168 is mounted on the surface of processor 166 to dissipate heat. Fan 146 provides additional cooling to SBC 116 and the associated microprocessor 166 and other circuitry to lower the operating temperature and to improve efficiency.

Also located on power distribution board 124 is a socket 147 for connecting a ribbon cable 148 to SBC 116 via an SBC header connector 149. Ribbon cable 148 provides data communications between Flash Disk™ 164 and hard disk controller located on SBC 116 via header connector 149.

A power socket 150 on distribution board 124 is connected to a power socket 152 on the backplane board 108 via a wire harness 151. Wire harness 151 distributes the various voltages to the backplane board 108, and indirectly to SBC 116, via PIC MG connector 118.

Cable 154 plugs into a 10/100 Ethernet communication port 155 on SBC 116. This network port may be used by a system administrator to control operation of router 10 from a remote location. Port 159 is used for connecting a keyboard so that a system administrator may interface with the system. It is also possible to access a web browser interface and secure shell command line interface by way of the Internet through this port. Web browser interface and secure command line interface are features provided on the Flash Disk™. In practice, this is the only network port through which an administrator may obtain access to the system for configuring or otherwise operating the router. The network ports present on NICs 102-106 are dedicated to routing data packets from point to point and not to access the SBC and associated operating software.

A ribbon cable 160 is used to interconnect a video header 157 with D-SUB connector 84. Connecter 84 can be used to communicate with an external video monitor. Ribbon cable 156 is used to connect a serial port header 161 to D-SUB connector 84 which can be connected to any device such as a computer, which communicates using the RS-232 serial protocol. These two ribbon cables 156, 160 are used for connecting a display monitor and a device using the RS-232 protocol to the SBC 116. A cable 158 provides connection between an I/O port 159 and circular pin connector 80 for connecting a keyboard. A parallel port 182 provides a connection point for SBC 116 to another port 210 on the backplane board. Ports 182, 210 are connected by a ribbon cable 165, which provides input and output signals to the LED array 46-56 and to an E²PROM chip 176. E²PROM stands for electrically erasable programmable read-only-memory, and is a non-volatile data storage unit.

Flash Memory™ disk 164 is mounted on the power distribution board 124. In the preferred embodiment, the Flash Memory™ disk 164 is a 64 MB or 128 MB read-write memory device. Alternatively, any computer hard disk or memory storage device may be used. On this Flash Memory™ disk 164, an operating system and ancillary software for adaptive firewall protection, routing program, and anti-virus and other security programs are few examples of programs that may optionally reside on the disk 164.

The software program is loaded onto the SBC 116 via cable 148. The program is loaded onto SBC memory 172 from disk 164, and is executed from memory 172 on SBC 116. A new program, if desired, may be loaded onto disk 164 through one of the network ports. This is loaded on via the processor heat sink 168, preferably with secure shell command line interface, to control access to the router system.

In the preferred embodiment of the present invention, an adaptive firewall and intrusion detection system developed by Captus Networks Corporation is used. This program is referred to as a traffic limiting intrusion detection system (“TLIDS”). Alternately, or in conjunction with TLIDS, a packet daemon embodiment (the “Pktd” embodiment) may be employed. The methods of these programs are described in detail in U.S. patent application Ser. No. 09/844,794 filed Apr. 27, 2001, and is herein incorporated by reference. In addition to the intrusion detection and intelligent adaptive firewall systems, other software features may be advantageously provided, for example, network load-balancing software.

Onboard SBC 116 is a microprocessor 166. Typically, this might be a microprocessor device, such as an Intel Pentium 4, or an equivalent AMD processor. Any number of microprocessor devices may be used, and these two devices are merely for example and not to limit the optional processors that may be used. Heat sink 168 is mounted on top of processor 166 so as to dissipate the energy built up in the processor during operation. A PCI to microprocessor bridge 170 is shown. This processor bridge is used to electronically couple the processor 166 with connector 118. Processor 166 is coupled with PCI bridge 170 by a bus on the SBC (not shown). PCI bridge 170 then sends signals to edge card connector 118. SBC 116 has a set of edge card fingers that are not shown, that interface with connector 118 to connect SBC 116 to backplane board 108.

Also shown on SBC 116 is random access memory (“RAM”) 172. RAM is preferably a plug-in PCB or memory stick, which is inserted into socket connector.

The E²PROM chip 176 is shown on backplane board 108. Providing the E²PROM on the backplane board provides the advantage of a software readable serial number for the backplane itself. This allows the router software or other administrative software to verify that it has access to a bona fide or authorized backplane prior to operation. Also shown on backplane board 108 is an LED connector 178. Connector 178 is used to connect the LED bank 46-56 to parallel port connector 210. A cable 180 is used to connect the LED bank 46-56 to connector 178.

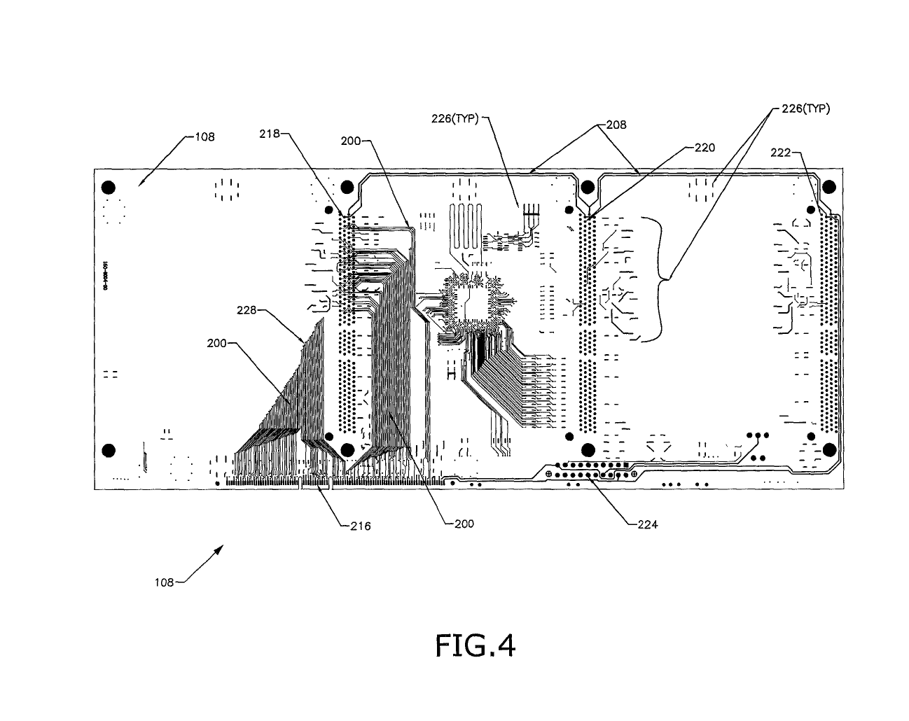

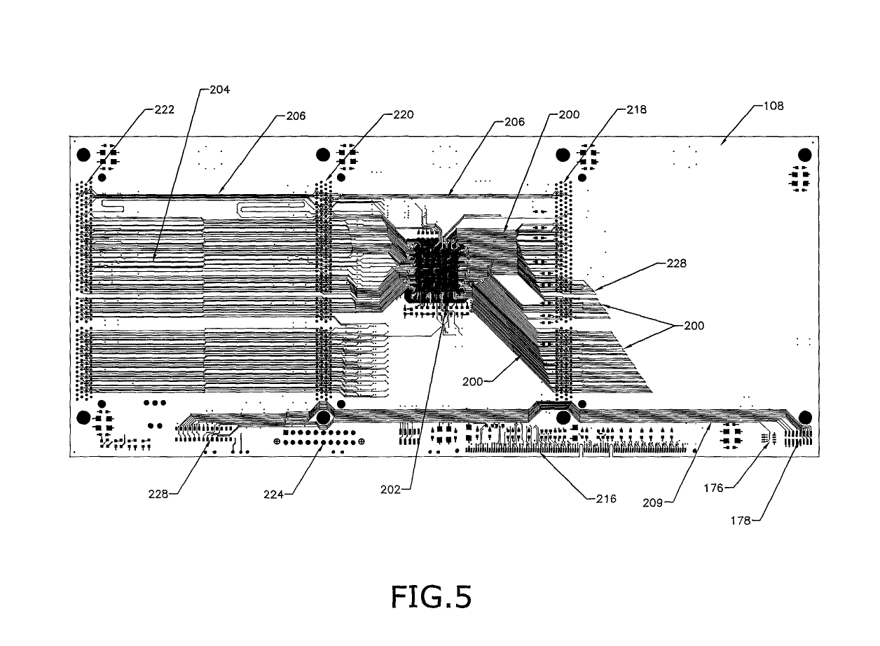

Referring next to FIG. 4, a bottom plan view of the PCB for the 64-bit/66 MHz active backplane is shown. It is apparent that primary bus 200 is an extension of the primary bus 200 from the topside as shown in FIG. 5. Penetration points 228 correspond to the penetration points 228 shown in FIG. 4. The primary bus 200 lead traces extend out from the penetration points 228 to the PIC MG port 216. The primary bus 200 extends on the bottom side to the upper portion of a primary connector socket 218.

A PCI bridge 202 is connected at a location on the bottom side of the substrate. The bridge itself is not shown, only the connection points where the bridge is to be attached. Bridge 202 couples the primary PCI bus 200 to the secondary PCI bus 204 while synchronizing and buffering the data for communication back to the PCI chip 170 onboard SBC 116, and ultimately to processor 166 for transferring data through the router.

Power lines 208 extend across the top of board 108 and provides +/−12 VDC to the NIC cards 102-106.

The two remote NIC cards 104,106 are electronically coupled to primary bus through PCI-to-PCI bridge interface 202; the nearest NIC connector or “primary” connector is directly connected to PIC MG (64 bit) port 216 via primary bus 200.

PCI-to-PCI bridge interface 202 provides buffering and synchronization of data packets with clock pulse to compensate for differences in the arrival times between the data and clock pulses. The improved router backplane utilizing the 64-bit/64 MHz PCI bus backplane effectively quadruples the operating speed of a passive backplane operating at 32-bit/33 MHz. A “throughput penalty” of about 5% is incurred by passing the data through PCI bridge chip 202.

PCI circuit elements are designated generally as 226. These elements represent coupling capacitors and terminating resistors. Since they are specified by PCI standards, the placement and interconnections are not shown, but will be readily apparent to one who is skilled in the art.

Referring next to FIG. 5, a top plan view of the 64-bit/66 MHz active backplane is shown. Primary bus 200 lead traces are shown. Primary bus 200 is comprised of a plurality of individual traces, which in the aggregate define the PCI primary bus 200. The primary bus 200 extends out to the primary I/O port of PCI bridge 202. Buses 200, 204 converge toward the center of board 108 in a densely packed set of copper traces, which appear in this view to be a solid rectangle, but are microscopically etched as individual lines which communicate signals to the bridge 202 mounted on the bottom side of the board 108. The secondary bus 204 couples two secondary connector sockets 220 and 222 to the secondary port of PCI bridge 202. Primary bus 200 is coupled to primary connector 218. In FIGS. 4 and 5, what are referred to as connectors 218-222 are hole pattern arrays, or “footprints” to which the physical connectors 108-112 are attached. In this discussion, they may be interchangeably referred to as connectors.

Primary bus 200 leads penetrate the bottom of the substrate through to the bottom at a series of points 228 of backplane board 108. In addition to primary data bus 200 and secondary data bus 204, there is an interrupt bus 206 (comprised of four interrupt lines A, B, C and D), which interconnects all three of the connector sockets 218, 220 and 222 with processor 116. The four interrupt lines are not buffered by the PCI bridge chip.

Additionally, a parallel bus 209 is shown comprising a plurality of electrical trace leads between a parallel port 230 and the LED array connector 178 and E²PROM 176.

Also shown in FIG. 5 is a PIC MG port 216. Port 216, comprised of a plurality of contacts, is the terminus of the primary bus 200 on the bottom side of the backplane board 108. Additionally, a power connection point 224 is shown. This connection point 224 is electrically coupled with the socket 150 on the power distribution board 124 by way of a wire harness 151.

### Laboratory Performance Tests

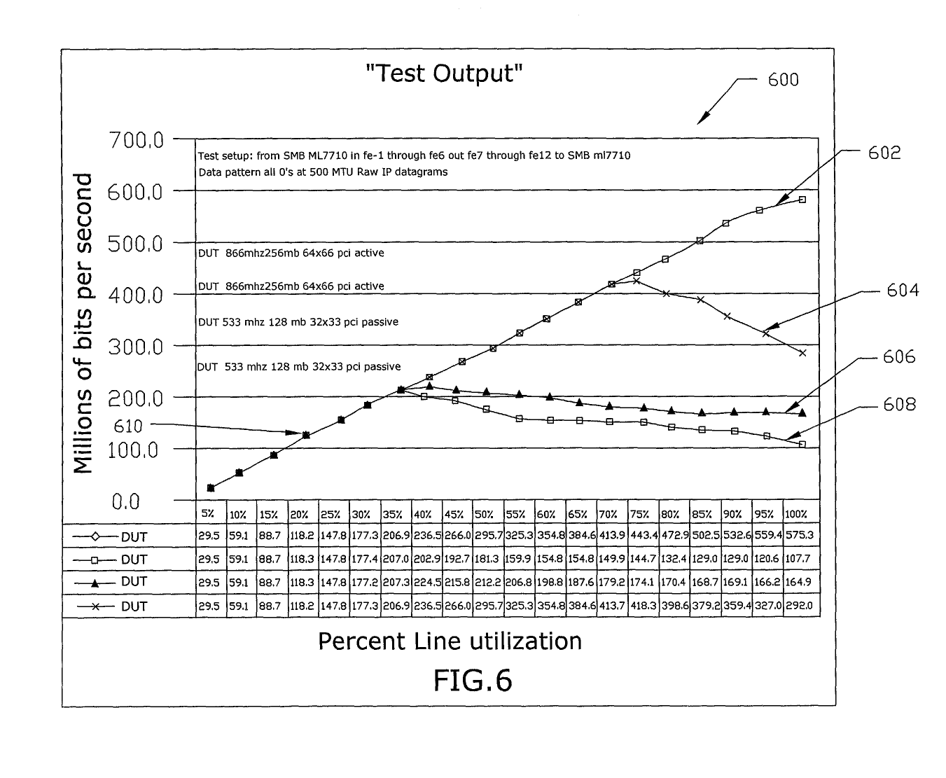

FIG. 6 is a graphic illustration of the throughput comparisons between the present invention and through standard backplane routers. Analysis of the network performance or “throughput” at 100% line utilization, in various configurations disclosed at the present invention PCI-active backplane configured for 64-bit/66 MHz operation, transferred filter data at approximately four times (3.4888) the rate of the passive backplane router operating at 32-bit/33 MHz.

The throughput of the present invention was approximately six times (5.342) that of the previous active backplane operating at 32-bit/33 MHz.

Similarly, throughput of a 64-bit/33 MHz active backplane operating at 100% line utilization was approximately one-half that of the present invention.

Throughput analysis was performed within an industry standard network performance analyzer “SmartBits™ 2000” manufactured by Spirent Communications, Inc. Testing was done on 10/100 base-TX Ethernet ports. It is predictable that comparable results would occur for comparable ports, e.g., Gigabit Ethernet.

Test results confirm that the doubling of the width of the data bus from 32 to 64-bit, doubles the system throughput; and further doubling of throughput is attributable to doubling of the bus speed (33 MHz to 66 MHz).

A “penalty” of approximately 5-10% in the throughput is realized due mostly to latency introduced by the PCI bridge. This latency is inherent when using a PCI-to-PCI bridge chip and is due to the need to resynchronize the transmission line data with the clock pulses coming from the PCI bridge 170 located on SBC 116. In order to compensate for differences in the arrival times of the clock signals and the address-data signals, a PCI bridge is inserted in the circuit to synchronize and buffer the signals between the primary and secondary sides of the bridge. In doing so, the bridge creates a delay, which in this case results in the 5-10% throughput penalty.

Referring next to FIG. 7, there is shown a graph 600 of comparison test results between four routers utilizing different backplane configurations. The vertical or y-axis represents millions of bits per second (Mbps) of throughput. The scale is graduated in 100 Mbps increments. The horizontal or x-axis represents percent line utilization over the range of zero to one hundred percent (0-100%).

Line 602 traces the coordinates indicating throughput performance of the router of the present invention. Line 604 traces the coordinates of throughput of a second router employing a 64-bit/33 MHz active backplane. Line 606 traces the coordinates of throughput of a third router employing a 32-bit/33 MHz passive backplane. Line 608 traces the coordinates of throughput of a fourth router employing a 32 bit/33-MHz active backplane.

The test was set up using a connection from a SmartBits SMB 7610 port (fe-1) into router port fe-6, and out of a router port fe-7 to a port fe-12 of another SMB 7610. These were constants for each router configuration tested. The data pattern consisted of all 0s with an overall frame size of 1500 bytes per packet transmitted. The 64 bit systems were each tested while running on an 866 MHz CPU with 256 MB of RAM; the 32-bit systems were tested while running on a 533 MHz CPU and 128 MB of RAM. The differences were necessitated, as the 32-bit systems were not compatible with any faster CPU speeds or greater memory.

As is illustrated in FIG. 7, all systems performed identically at utilization percentages below 35%. Above 35% line utilization, the performance characteristics diverge. The router of the present invention, represented by the performance curve 602, exhibits a nearly straight-line trajectory over the entire utilization range, with a slight decay above 95% line utilization. This decay is generally attributed to latency introduced by the PCI bridge 202 at full capacity.

The next best performance was produced by the second 64-bit backplane operating at a bus speed of 33 MHz. Performance was linear from 0 to 70% line utilization, then leveled off to 75%, and decreased markedly above 75%, to approximately 50% of the first line 602 router at 100% line utilization.

The 32-bit/33 MHz passive backplane router was the third best performer as shown by line 606. The performance leveled off at 35 to 40% line utilization and performed approximately at the same level above 35%, with a gradual decline from 224.5 Mbps at 40%, to 164.9 Mbps at 100%.

The fourth router operating at 32-bit/33 MHz, with an active backplane, peaked at 207 Mbps at 35% line utilization, and decayed linearly to 107.7 Mbps at 100% line utilization. This demonstrates the disadvantage of the PCI bridge latency in the 32-bit/33 MHz operation.

### 64-bit/66 MHz Design Hurdles

Advances in components and industry standards have allowed increased bus operation at 66 MHz, and transmission of data on a 64-bit bus. The increased bus speed and bus width are sufficient to surmount performance limitations, which were previously obstacles at the slower bus speed and limited bus width.

Increasing the bus frequency and width to 64-bit/66 MHz creates design hurdles that are more complicated than simply doubling the frequency of the bus or buses. The limitation on the length of the PCI signal lines (bus) is due to the “race” between clock signals which are intercepted by each point on the line as they pass, and the address-data signals which must travel to the end of the transmission line and then be reflected back to any given point before the signal level becomes valid. Over short distances both signals arrive almost at the same time, but as line lengths increase the time required for the address-data signal to become valid starts to mount up. At some length the clock signal will latch the old, invalid data into the receiving chip before the valid data has a chance to reflect back and drive the node to the correct voltage level. This imposes severe restrictions on the length of the data bus over which the signal may be transmitted without compromising the accuracy of the data.

PCI bus design standards suggest that equalization of length of the bus leadwires is necessary in order to maintain the synchronization between the clock pulses and the address-data line signals. At 33 MHz, the bus lengths can be extended the full length of the backplane board without violating the timing parameters of the PCI specification. At 66 MHz, however, the additional line length between the SBC and the backplane connectors becomes too great for communication to the most distant two connectors 112, 114. The data signal will not be present on the bus at the leading edge of the next clock pulse, which occurs one period later, or 15 nanoseconds after the previous clock pulse. It should be noted that the first PCI connector 110 is within an acceptable distance that does not require a bridge chip to compensate for delay. The primary bus connecting the first PCI connector also has unequal lead lengths.

The lead lengths become a factor in the present invention also because of the desired geometry and density of the ports 28-40. In order to achieve the physical relation of the NIC cards 102-106 disposed in a horizontal plane, parallel with the backplane board 108, it is necessary to maintain a minimum spacing of approximately four to five inches between each of the right-angle connectors 110-114. It is possible for the lead lengths to be equalized, which results in a less desirable configuration. In order to equalize the lead lengths, the NIC cards 102-106 must be positioned vertically, and perpendicular to the plane of backplane board 108. The vertical positioning of the NIC cards 102-106 enables the cards to be placed closer together, but at the same time defeats the desired height restrictions. Thus, the router 10 of the present invention, the height or profile of the router is desirably limited to the industry standard height for a single mounting rack slot.

Providing diagnostic LEDs on the backplane board permits evaluation of the operation of the power supply apart from the operation of the active circuitry on the NICs or on the SBC. The novel router of the present invention also provides the advantage that the sequential numbering of the ports when a plurality of ports is present proceeds from one end of the aligned ports to the other, such that port one is logically the first and left-most port proceeding in increasing numerical sequence to port twelve at the right-most portion of the aligned ports. Known routers do not have this capability and it is not at all intuitive where port one is located along the aligned string of ports. Further, unlike other known router systems employing an active backplane, it is not necessary to populate each and every NIC-receiving electronic circuit board expansion slot located on the backplane board substrate for the backplane board to operate.

It should also be noted that the router of the present invention is capable of operating with 32-bit NIC cards, although doing so fails to take advantage of the 64-bit capability of the active backplane system, and greatly compromises throughput performance.

Also disclosed in detail above is an improved method for routing data through a network comprising the steps of providing an active backplane board for coupling an external network data path with an SBC program to route data through a network; providing at least two data buses, each data bus made up of a plurality of electrical pathways on the backplane, with a plurality of electronic circuit board expansion slots located on the backplane substrate in data communication with one of the buses;

adapting each slot to receive a network interface card and coupling the NIC to one of the data buses while at the same time retaining the NIC in a spaced apart relation from, but in a plane generally parallel with, the backplane board substrate;

providing a means for electrically coupling a first data bus to a single board computer; and

further providing at least one bridge means for electronically coupling the two (or more, if applicable) data buses; with the bridge means providing buffering and synchronization of data transferred between the at least two data buses; with the PCI bridge means having at least a primary port and a secondary port for bi-directional communications with the SBC.

In one embodiment, the method includes adapting the bridge means for communication according to an industry standard PCI protocol for 64-bit/66 MHz communication to and from a SBC while further adapting each of the expansion slots for a right angle electrical connection slot expansion slot extending vertically from the substrate and turning at a right angle to project horizontally for and inserting therein a PCI compatible card, such as an NIC, with the NIC being adapted to interface to T-1, OC-*, token ring, ARCNET, V.35, FDDI, ATM, DSL, or ISDN; and integrating within the operating system for routing data, intelligent, adaptive firewall system, intrusion detection system, or network load balancing system or any combination thereof.

According to the provisions of the patent statutes, we have explained the principle, preferred construction, and mode of operation of the invention, and have illustrated and described what we now consider to represent its best embodiments. However, it should be understood that within the scope of the appended claims and the foregoing description, the invention may be practiced, otherwise than specifically illustrated and described.

We claim:

1. An active backplane board for coupling an external network data path with a single board computer for routing data through a network, comprising:
a. a backplane board substrate having at least two data buses, each data bus comprising a plurality of electrical pathways;
b. a plurality of electronic circuit board expansion slots located on said substrate and in data communication with one of said buses, each slot adapted to receive a network interface card, and couple said network interface card to one of said data buses, and to retain said network interface card spaced apart from but in a plane generally parallel with said backplane board substrate;
c. a means for electrically coupling a first said data bus to a single board computer; and
d. at least one bridge means for electronically coupling said at least two data buses;
wherein said bridge means providing buffering and synchronization of data transferred between said at least two data buses; and
said bridge means having at least a primary port and a secondary port.

2. The active backplane board of claim 1, wherein first said expansion slot being electrically common through first said data bus with the primary port means of said bridge and with the coupling means of said single board computer; and
a pair of said expansion slots being electrically common with a second said data bus, and said second data bus also being electrically common with said first bridge secondary port means.

3. The active backplane board of claim 2, wherein each said successive pair of slots being electronically coupled to said preceding pair of slots through an associated said bridge means.

4. The active backplane board of claim 3, wherein said bridge means comprises a peripheral component interconnect (PCI)-to-PCI bridge chip.

5. The active backplane board of claim 4, wherein said means for coupling the single board computer comprises a PIC MG standard form connector mounted on an edge of said backplane board.

6. The active backplane board of claim 5, wherein each of said expansion slots comprising a right angle electrical expansion slot extending vertically from said substrate and turning at a right angle to project horizontally for insertion of a PCI compatible card.

7. The active backplane board of claim 6, wherein at least one of said PCI compatible cards is a network interface card.

8. The active backplane board of claim 7, wherein said network interface card is compatible with an Ethernet protocol and is adapted to interface to one or more of the group consisting of: T-1, OC-*, token ring, ARCNET, V.35, FDDI, ATM, DSL, and ISDN.

9. The active backplane board of claim 8, wherein said bridge chip is capable of operating at up to 66 MHz.

10. The active backplane board of claim 9, wherein said data buses are compatible with 64-bit transmission.

11. The active backplane board of claim 10, wherein said backplane board further comprises an E²PROM memory chip.

12. The active backplane board of claim 11, wherein said E²PROM memory chip is in data communication with a single board computer, said E²PROM memory chip further comprising a means for providing an identifying item to said single board computer, whereupon said single board computer upon receiving said identifying item permits a router employing said backplane board and said single board computer to operate.

13. The active backplane board of claim 12, wherein said identifying item is selected from the group consisting of a hardware serial number associated with said backplane board, a data key, and combinations thereof.

14. The active backplane board of claim 13, wherein said backplane board further comprises an electrical pathway for a plurality of light emitting diodes.

15. The active backplane board of claim 14, wherein said plurality of pathways is of unequal lengths between connections, wherein individual pathways may be shortened without regard to equalization of the bus electrical pathways.

16. A router device having an active backplane, comprising:
a. a housing having a removable access panel, including ventilation means and power distribution means;
b. a plurality of data communication ports accessible externally of said housing, said ports residing on and in data communication with at least one network interface card;
c. a single board computer;
d. memory storage means; and
e. an active backplane board interposed between said network interface card and said single board computer, said backplane board providing data communication between said network interface card and said single board computer, said backplane board comprising a backplane board substrate having at least two data buses, each data bus comprising a plurality of electrical pathways; a plurality of electronic circuit board expansion slots located on said substrate and in data communication with one of said buses, each slot adapted to receive a network interface card, and couple said network interface card to one of said data buses, and to retain said network interface card spaced apart from but in a plane generally parallel with said backplane board substrate; means for electrically coupling a first said data bus to a single board computer; and at least one bridge means for electronically coupling said at least two data buses, said bridge means providing buffering and synchronization of data transferred between said at least two data buses; said bridge means having at least a primary port and a secondary port;
wherein said network interface card is retained within said network interface card-receiving electronic circuit board expansion slot in a spaced apart but generally parallel plane with said backplane board substrate and wherein said router housing is approximately one rack unit in height.

17. The router of claim 16, wherein said backplane board comprises a plurality of network interface card-receiving electronic circuit board expansion slots.

18. The router of claim 17, wherein a portion of said plurality of electronic circuit board expansion slots is populated with a network interface card and a portion of the electronic circuit board expansion slots is not populated with a network interface card.

19. The router of claim 18, wherein said backplane board comprises three network interface card-receiving electronic circuit board expansion slots.

20. The router of claim 19, wherein the group of electronic circuit board expansion slots populated with a network interface card is selected from the group consisting of one, two and three of said electronic circuit board expansion slots.

21. The router of claim 20, wherein said data communication ports are selected from the group consisting of 10/100 megabit ports, one gigabit ports, and combinations thereof.

22. The router of claim 21, wherein each of said network interface cards includes four data communications ports, and each of said data communications ports is 10/100 megabit ports.

23. The router of claim 21, wherein said means for providing data communication between said backplane board and said single board computer is a PCI Industrial Computer Manufacturing Group PIC MG connector.

24. The router of claim 23, wherein said backplane board further comprises at least one E²PROM memory chip.

25. The router of claim 24, wherein said E²PROM memory chip is in data communication with said single board computer, said E²PROM memory chip further comprises a means for providing an identifying item to said single board computer, whereupon said single board computer upon receiving said identifying item permits a router employing said backplane board and said single board computer to operate.

26. The router of claim 25, wherein said identifying item is selected from the group consisting of a hardware serial number associated with said backplane board, a data key, and combinations thereof.

27. The router of claim 23, wherein an item selected from the group consisting of said housing, said backplane board, and combinations thereof further comprises a plurality of light emitting diodes.

28. The router of claim 27, also comprising a second plurality of light emitting diodes is adapted to provide a visual indication of the real time network utilization rate of said backplane board.

29. The router of claim 28, wherein during operation in a high availability mode, at least a portion of said light emitting diodes displays said network utilization rate, and a portion of said light emitting diodes displays high availability heartbeats in blinks per unit of time.

30. The router of claim 23, wherein said data communications ports are horizontally aligned along the same line of axis and are sequentially numbered such that when a plurality of ports is present, the ports are sequentially identified from one end of the aligned ports to the other, wherein port one is the first and left-most port, the second left-most port is port two, and the remaining ports are sequentially numbered in increasing numerical sequence proceeding to the right-most port.

31. The router of claim 23 further comprising an operating system associated with the single board computer.

32. The router of claim 31, wherein said memory storage means comprises a solid state static memory disk.

33. The router of claim 32 further comprising a means for configuring said operating system.

34. The router of claim 33, wherein said means is selected from the group consisting of a computer keyboard and interface, computer monitors and interface, serial data communications ports, parallel data communications ports, computer terminals, and combinations thereof.

35. The router of claim 23 further comprising a plurality of cooling fans retained within said housing.

36. The router of claim 35, wherein said cooling fans are powered by one or more power takeoffs from said power distribution board, at least a portion of said power takeoffs further comprising a polyfuse.

37. The router of claim 23, wherein said router being adapted to operate with a peripheral computer interface bus supporting up to 64-bits and 66-megahertz clock speed.

38. The router of claim 23, wherein said memory storage means includes a computer executable software program for adaptive firewall protection.

39. The router of claim 38 further comprising a computer executable software program for denial of service protection.

40. An improved method for routing data through a network comprising the following steps:
a. providing an active backplane board for coupling an external network data path with an SBC programmed to route data through a network;
b. providing at least two data buses, each data bus made up of a plurality of electrical pathways on the backplane, with a plurality of electronic circuit board expansion slots located on the backplane substrate, in data communication with one of the buses;
c. adapting each slot to receive a network interface card, and coupling the NIC to one of the data buses while at the same time retaining said NIC in a spaced apart relation from, but in a plane generally parallel with the backplane board substrate;
d. providing a means for electrically coupling a first said data bus to a single board computer; and
e. providing at least one bridge means for electronically coupling said the two (or more, if applicable) data buses; with said bridge means providing buffering and synchronization of data transferred between said at least two data buses; with the PCI bridge means having at least a primary port and a secondary port for bi-directional communications with the SBC.

41. The method of claim 40, also comprising the steps of:
a. adapting the bridge means for communication according to an industry standard PCI protocol for 64-bit/66 MHz communication to and from an SBC;
b. adapting each of said expansion slots for a right angle electrical connection slot expansion slot extending vertically from said substrate and turning at a right angle to project horizontally for and inserting therein a PCI compatible card, such as an NIC, with the NIC being adapted to interface to T-1, OC-*, token ring, ARCNET, V.35, FDDI, ATM, DSL, or ISDN; and
c. integrating within the operating system for routing data, intelligent, adaptive firewall system, intrusion detection system, or network load balancing system or any combination thereof.
